(19) United States
(12) Patent Application Publication
(10) Pub. No.: US 2012/0219277 A1
(43) Pub. Date: Aug. 30, 2012

(54) Luminaire, Camera or Camcorder Having Same and Optical Element for a Luminaire

(76) Inventors: Ulrich Hartwig, Berlin (DE); Henning Rehn, Berlin (DE)

(21) Appl. No.: 13/504,695

(22) PCT Filed: Oct. 18, 2010
(86) PCT No.: PCT/EP10/65610

§ 371 Date: Apr. 27, 2012

(30) Foreign Application Priority Data
Oct. 27, 2009 (DE) 10 2009 050 805.8

(51) Int. Cl. G03B 15/02; G03B 15/03; F21V 5/00; F21V 5/04

(52) U.S. Cl. 396/62; 362/268; 362/235; 396/155; 362/326

(57) ABSTRACT

A luminaire (100) comprising: a, a radiation source (16), a first optical element (10a) and a second optical element (10b) each with a non-planar surface (14a, 14b), wherein, in a base state, the second optical element (10b) engages in the first optical element (10a) with its non-planar surface (14a) in an exact fit, wherein the first and the second optical element (10a, 10b) are movable relative to each other, and wherein the first and the second optical element (10a, 10b) are identical in construction.

### TECHNICAL FIELD

The invention relates to a luminaire as claimed in the preamble to claim 1. It also relates to an optical element suitable for a luminaire of this kind. There are numerous possible applications for a luminaire of this kind, for example, it can be integrated in a camera or a camcorder.

### PRIOR ART

A luminaire as claimed in the preamble of claim 1 is already known from DE 39 26 618 A1.

This describes a light source, namely a low-voltage halogen lamp in a reflector with two downstream optical elements in the beam path of the light, namely auxiliary disks made of a translucent material. The auxiliary disk adjacent to the reflector is provided with elevations and the anterior auxiliary disk with indentations. These indentations fit into each other. The elevations are circular and arranged concentrically. The anterior auxiliary disk is adjustable in the axial direction of the reflectors.

In a base state, in which the auxiliary disks engage into each other, the two auxiliary disks work together like a planar parallel plate and so do not influence the beam path. If the anterior auxiliary disk is now displaced, the light bundle is thereby expanded.

The production of a reflector luminaire of this kind requires the production of two different elements, namely the one auxiliary disk with elevations and the other auxiliary disk with indentations.

### DESCRIPTION OF THE INVENTION

The object of the present invention is to provide a luminaire as claimed in the preamble to claim 1, which is simple and therefore inexpensive to produce.

This object is achieved with a luminaire with the features of the preamble of claim 1 and by the features of the is characterizing portion of claim 1. Particularly advantageous embodiments can be found in the dependent claims.

Hence, according to the invention, the first and the second optical elements are identical in construction.

Therefore this is a departure from the concept that one optical element is provided exclusively with elevations and the other exclusively with indentations. Instead, the single optical element has both elevations and indentations, which are arranged matching each other such that the same optical element can serve as both the first optical element and the second optical element in the luminaire. To produce the luminaire according to the invention, therefore, only one manufacturing process is required for both optical elements. For example, the optical elements can be produced by injection molding then only one injection mold is required, instead of two as is the case in the prior art.

The invention is based on the fact that rotating the respective element relative to the element which is identical in construction enables a fit to be obtained. For example, the non-planar surface preferably has the property that, with respect to a rotary axis, the elevation F(r,Θ) has the property:

$$F ( r , Θ ) = - F ( r , Θ + \frac{360 °}{n} ) ,$$

wherein r is the distance from the rotary axis and Θ is the angle of rotation and wherein n=2, 4, 6, 8, . . . (that is n is a whole number multiple of 2; in the following, n will also be referred to as a multiplicity).

It has been found to be advantageous if the function F(r,Θ) is separable, for, therefore, the following to apply: F(r,Θ)=A·f(r)·p(Θ) with

$$p ( Θ ) = - p ( Θ + \frac{360 °}{n } ) .$$

Here, f(r) is any function of r. It is particularly advantageous for the symmetry condition to be fulfilled piecewise in dependence on the radius, namely when the following applies:

$$F ( r , Θ ) = {\sum }_{m = 1}^{N} {A}_{m} ( r ) \cdot {f}_{m} ( r ) \cdot {p}_{m} ( Θ ) ,$$

with

$${p}_{m} ( Θ ) = - {p}_{m} ( Θ + \frac{360 °}{n} ) ,$$

Aₘ(r)=Aₘ=cst for r∈[rₘr_{m+1[,r}ₘ₊₁>rₘ and Aₘ(r)=0 for r∉[rₘ,rₘ₊₁[, are N≧2 elements of the natural numbers and fₘ(r) functions of r, which are preferably continuous and continuously merge into each other at the points^{r}^{ₘ}, that is

$$( {lim}_{r -> {r}_{m + 1}} {f}_{m} ( r ) = {lim}_{r -> {r}_{m + 1}} {f}_{m + 1} ( r ) ) .$$

If patterns of different multiplicity n are superposed in the far field, this enables a reduction in the contrast of patterns that occur in the far field.

When the symmetry requirements are fulfilled, it is possible to use any patterns, even purely random patterns.

To ensure that when there is a fit, that is in the base state, the two optical elements function as a planar parallel plate and do not influence the beam path, they preferably have a s planar surface on the surface facing away from the non-planar surface. Here, the planar surface of the first optical element preferably points toward the light source.

An anti-reflection coating on the optical elements can lo advantageously be provided by means of nanostructures since this makes the transmission extensively independent of the angle of incidence.

The invention is particularly also suitable if the light source is comprises at least one or more light-emitting diodes. One or more lenses can be arranged between the light source (preferably a light-emitting diode) and the two optical elements.

Preferred applications of the invention include a camera or a camcorder: sliding the two optical elements relative to each other for purposes of beam expansion then permits the illumination of the scenario to be recorded according to the lens settings: for wide-angle recording, the beam tends to be expanded, while a narrow light source beam bundle is sufficient for telephotography. The sliding of the two optical elements of the luminaire is therefore coupled with the optical zoom function of a camera or camcorder. Here, the light source can be operated continuously or provided as a flashlight. Examples of applications include pocket lights, examination lights and microscope illumination.

Another application involves general lighting, for example the use of the two discs as auxiliary optics for downlights, in order to be able to set the angle of radiation.

According to the invention, an optical element for a luminaire according to the invention is also provided, i.e. with the properties already described above.

### BRIEF DESCRIPTION OF THE DRAWINGS

The following is a more detailed explanation of the invention with reference to an exemplary embodiment; the drawings show:

FIG. 1 a top view of optical element according to the invention to explain the magnitudes used,

FIG. 2 a side view of an optical element according to the invention and

FIG. 3 a section through a luminaire according to the invention,

FIG. 4a a top view of a quadratic arrangement with four luminaires according to FIG. 3,

FIG. 4b a side view of the arrangement in FIG. 4a,

FIG. 5 a variant of the arrangement in FIGS. 4a, 4b,

FIG. 6 a schematic top view of an arrangement with four quadratic luminaires,

FIG. 7 a schematic top view of a hexagonal arrangement with seven circular luminaires according to FIG. 3,

FIG. 8 a schematic top view of a hexagonal arrangement with s seven hexagonal luminaires.

### PREFERRED EMBODIMENT OF THE INVENTION

In the following, the same or similar features are given the lo same reference characters.

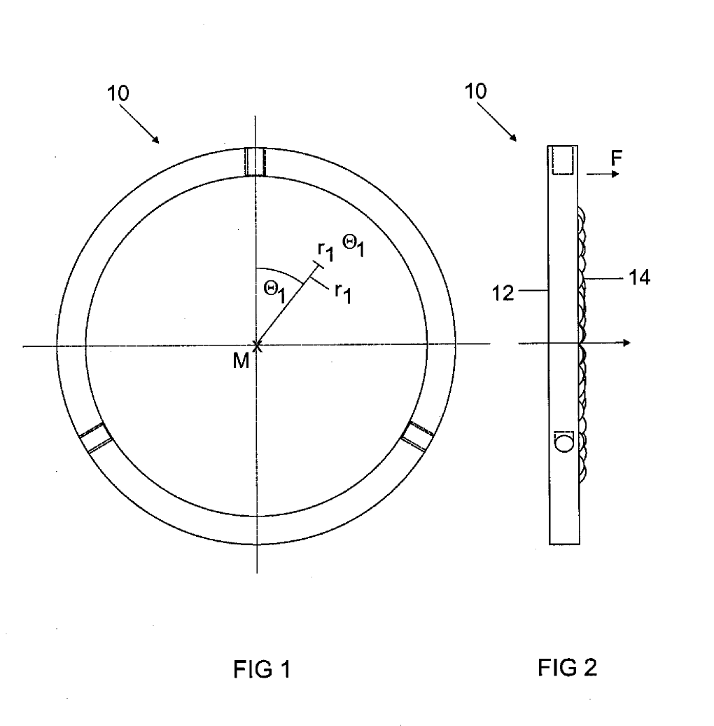

An optical element made of translucent Material in FIGS. 1 and 2 is designated 10 as a whole. On one side, it has a planar surface 12. On the opposite side, it has a non-planar, namely predominantly hilly surface 14.

In the example, the optical element 10 is embodied as a circular disc and the surface 14 as a circular area. It is appropriate to define polar coordinates. Shown by way of example is a point with the coordinates r₁ and Θ₁ wherein r₁ is the radius to the center point M and Θ₁ is the angle of rotation. The size of an elevation of a hill on the surface 14 at a point with the coordinates r and θ is defined by F(r,Θ).

Here, the following applies:

$$F ( r , Θ ) = - F ( r , Θ + \frac{360 °}{n} ) ,$$

wherein n is a whole number multiple of 2. This means that the free-form surface 14 is converted by rotation by 180° into a surface with the reverse profile.

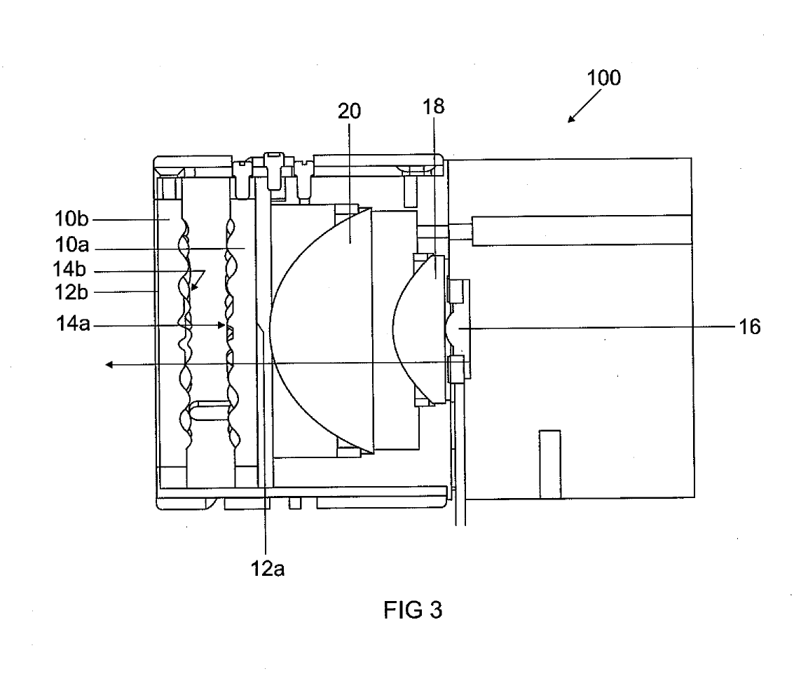

If there are two optical elements 10a and 10b, the surfaces 14a and 14b can be fitted together with an exact fit. In this base state, the entirety of the two optical elements 10a and 10b functions as a planar parallel plate, that is it does not influence the beam path of a light source. This is utilized in a luminaire 100, see FIG. 3: a light-emitting diode 16 emits light which passes through lens elements 18 and 20 to arrive at the first optical element 10a and then goes from this to the second optical element 10b and from there to the object to be illuminated (not shown).

FIG. 3 shows a state, in which the second optical element 10b is displaced from the first optical element 10a in the direction vertical to the surfaces 12a and 12b in the direction of the optical axis. This is the state in which an expansion of the light bundle can be achieved. The base state in which the surfaces 14a and 14b engage in each other with an exact fit is not shown; then, the light bundle is not influenced by the optical elements 10a and 10b.

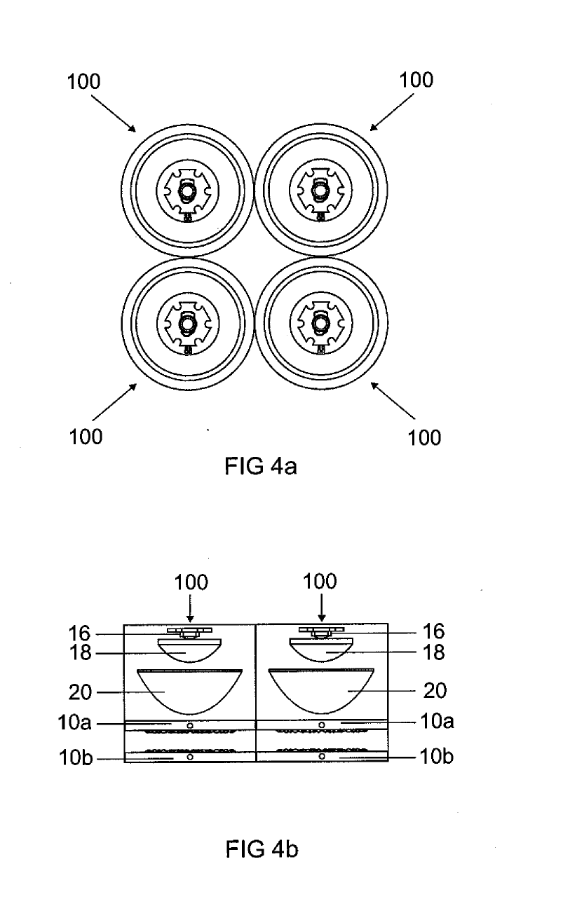

FIGS. 4a and 4b respectively show a top view and side view of an arrangement with four luminaires 100 which are explained in more detail in connection with FIG. 3. Here, the four luminaires 100 are arranged in the style of a two by two matrix in a plane. Here, the optical elements 10a, 10b can be moved independently of each other so that the radiation characteristics of each of the four luminaires 100 can be set individually. An arrangement of this kind is suitable for example as overhead lighting or other lighting purposes.

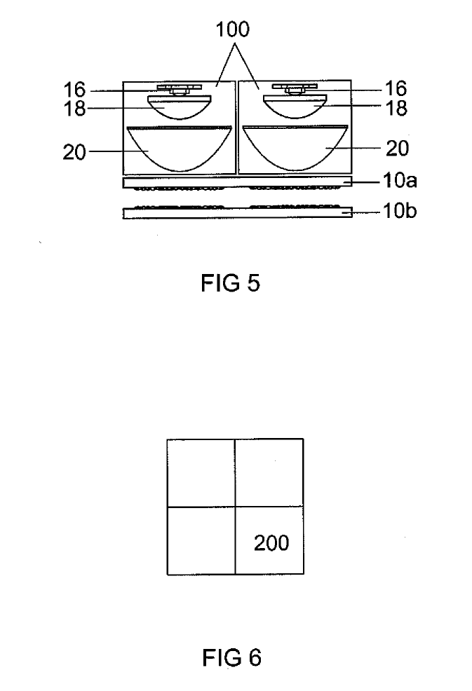

FIG. 5 shows a variant of the arrangement in FIG. 4, wherein here the optical elements 10a, 10b for all four luminaires 100 are each made in one part, i.e. in this variant, the optical elements 10a, 10b for all four luminaires can only be moved together.

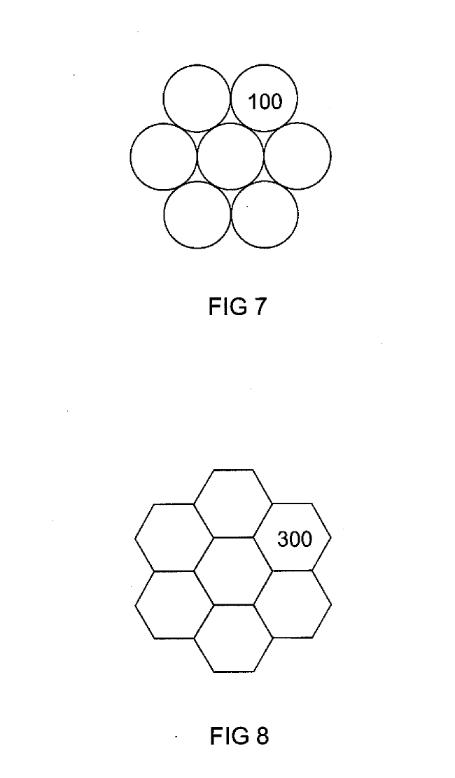

FIGS. 6 to 8 are extremely schematic representations of further arrangements of luminaires according to the invention, each in a vertical top view of the openings of the luminaires. FIG. 6 shows an arrangement in the style of a two by two matrix, i.e. similar to the arrangement shown in FIG. 4, but in this case with four luminaires 200 with a quadratic instead of a circular basic shape. FIG. 7 shows a hexagonal arrangement of seven circular luminaires 100. Finally, FIG. 8 also shows a hexagonal arrangement but with seven luminaires 300 each with a hexagonal lo basic shape.

In principle, the arrangements are not restricted to four or seven luminaires. Instead, the patterns can be continued in the common plane, in the cases of the quadratic, hexagonal and triangular basic luminaire shapes they can also be space-filling.

In addition, other basic shapes are also conceivable for the luminaires, for example circular and octagonal shapes, etc.

1. A luminaire comprising:
a. a radiation source;
b. a first optical element and a second optical element each with a non-planar surface,
wherein, in a base state, the second optical element engages in the first optical element with its non-planar surface in an exact fit and wherein the first and the second optical element are movable relative to each other, and
wherein the first and the second optical element are identical in construction.

2. The luminaire as claimed in claim 1, wherein the non-planar surface has the property that, in the direction of a rotary axis, the elevation F(r,Θ) has the property:
$$F ( r , Θ ) = - F ( r , Θ + \frac{360 °}{n} ) ,$$
wherein r is the distance from the rotary axis and Θ is the angle of rotation and wherein n is a whole number multiple of 2.

3. The luminaire as claimed in claim 2, wherein F(r,Θ)=A·f(r)·p(Θ), wherein A is a constant, f(r) is a function of r and p(Θ) has the property
$$p ( Θ ) = - p ( Θ + \frac{360 °}{n} ) .$$

4. The luminaire as claimed in claim 3, wherein
$$F ( r , Θ ) = {\sum }_{m = 1}^{N} {A}_{m} ( r ) \cdot {f}_{m} ( r ) \cdot {p}_{m} ( Θ )$$
with
$${p}_{m} ( Θ ) = - {p}_{m} ( Θ + \frac{360 °}{n} ) ,$$
Aₘ(r)=Aₘ=cst for r∈[rₘ,rₘ₊₁[,rₘ₊₁>rₘ and Aₘ(r)=0 for r∉[rₘ,rₘ₊₁[, are N≧2 elements of the natural numbers and fₘ(r) functions of r.

5. The luminaire as claimed in claim 4, wherein the functions fₘ(r) are constant and at the points rₘ continuously merge into each other, that is
$${lim}_{r -> {r}_{m + 1}} {f}_{m} ( r ) = {lim}_{r -> {r}_{m + 1}} {f}_{m + 1} ( r ) .$$

6. The luminaire as claimed in claim 1, wherein the optical elements comprise a planar surface on the side facing away from the non-planar surface.

7. The luminaire as claimed in claim 6, wherein the planar surface of the first optical element points toward the light source.

8. The luminaire as claimed in claim 1, wherein the light source comprises at least one light-emitting diode.

9. A luminaire having at least one lens between the light source and the two optical elements.

10. A camera or camcorder having a luminaire as claimed in claim 1.

11. The camera or camcorder as claimed in claim 10 having a zoom lens, wherein the movement of the two optical elements of the luminaire is coupled with the zoom function of the zoon lens.

12. An optical element with a non-planar surface comprising an elevation F(r,Θ) in the direction of a predetermined rotary axis wherein r is the distance of rotary axis and Θ is the angle of rotation about the rotary axis and wherein the non-planar surface has the property:
$$F ( r , Θ ) = - F ( r , Θ + \frac{360 °}{n} ) ,$$
wherein n is a whole number multiple of 2.

13. The optical element as claimed in claim 12, where F(r,Θ)=A·f(r)·p(Θ), wherein A is a constant, f(r) is a function of r and p(Θ) has the property
$$p ( Θ ) = - p ( Θ + \frac{360 °}{n} ) .$$

14. The optical element as claimed in claim 12, wherein
$$F ( r , Θ ) = {\sum }_{m = 1}^{N} {A}_{m} ( r ) \cdot {f}_{m} ( r ) \cdot {p}_{m} ( Θ )$$
with
$${p}_{m} ( Θ ) = - {p}_{m} ( Θ + \frac{360 °}{n} ) ,$$
Aₘ(r)=Aₘ=cst for r∈[rₘ,rₘ₊₁],rₘ₊₁>rₘ and Aₘ(r)=0 for r∉[rₘ,rₘ₊₁], are N≧2 elements of the natural numbers and fₘ(r) functions of r.

15. An arrangement having two or more luminaires as claimed in claim 1.
